(19) United States
(12) Patent Application Publication
(10) Pub. No.: US 2012/0118933 A1
(43) Pub. Date: May 17, 2012

(54) NAIL GUN WITH MULTI-GAUGE STRUCTURE

(76) Inventor: QUAN-FU ZHENG, Taichung City (TW)

(21) Appl. No.: 13/097,061

(22) Filed: Apr. 29, 2011

(30) Foreign Application Priority Data
Nov. 15, 2010 (TW) 099139156

(51) Int. Cl. B25C 1/00

(52) U.S. Cl. 227/120

(57) ABSTRACT

A nail gun comprises a case, a pressing element, and a clamping element. The case defines an inserting slot and a holding slot. Two positioning stops are respectively provided in the inserting slot. The pressing element has two strip supports respectively formed on two lateral sides, each strip support having a first positioning edge and a second positioning edge. Two recesses are defined on the pressing element. Each recess can accommodate a specific cable. The first or second positioning edges can be employed to engage with the positioning stops. The length of the pressing element out of the case can be directly determined by the first or positioning stops as well as the positioning edges to facilitate a design. Through the selection of a pressing element, one gun is sufficient to be applied for a variety of cables to facilitate the operation.

### (a) TECHNICAL FIELD OF THE INVENTION

The present invention relates to a nail gun and, more particularly to, a nail gun with a multi-gauge structure for a variety of cables to obviate the drawback of conventional art, by which more than one gun are required for securing different cables, and further to simplify the construction and facilitate the operation.

### (b) DESCRIPTION OF THE PRIOR ART

In the conventional electrical wiring, due to the cables generally having a certain amount of flexibility, general cables, such as power cables, telephones cables or signal cables, cannot be self-fixed along the routing path. Such cables are usually fixed via cable fasteners, which mainly include a seat having a recess on its bottom and a U-shaped staple fitted on the seat. The U-shaped staple can be driven down to be fixed into a wall and compress the seat to secure the cable. In order to improve the working efficiency, some dedicated device for driving staples to secure cables has been developed.

However, cables may each have a diameter different from each other. For example, telephone or signal cables for use in low voltage are generally manufactured to have a smaller size while cables for supplying power or for use in high voltage are manufactured to have a larger size. In addition to the size, a cable may be manufactured to have various cross sections. For example, the cross section of a cable can be round, oval, or other shaped. Therefore, if the cross-sectional shape of a cable does not conform to the recess of the cable fastener, the cable will not be fastened properly.

The design of nail gun has not yet arrived at the consummation. For improving the function of a nail gun, there is a Taiwan utility model published as No. M297298, which provided a cable-pressing structure for a nail gun, as can seen in FIGS. 12 and 12A. In the utility model, an inserting slot 58 and a holding slot 59 are respectively defined in front of the driving slot 53. The driving-blade 54 is slidably mounted in the driving slot 53 of the case 50. A pressing element 61 and an urging element 67 are mounted in the inserting slot 58. There are two recesses 640, 650 respectively defined at two ends 64, 65 of the pressing element 61. Each recess has a depth different from each other. The urging element has a tab 68 adapted to be engaged with one of the recess 640, 650 to have the first pressing end 64 or the second pressing end 65 extend out of the bottom of the case 50. Furthermore, an arch-shaped clamping element 62 is mounted in the holding slot 59 to retain the pressing element 61 in the inserting slot 58 of the case 50.

Although the aforementioned patent of prior art can solve some problems faced by the traditional techniques, the urging element 67, which is a component required to limit the insertion depth of the pressing element 61, will add some difficulty in designing a nail gun. One end of the pressing element 61 must extend out of the case 50 at a predetermined length to be applied for a cable. The predetermined length is affected by the urging element 67 and the recess engaged with the urging element 67. The depth of the recess at the other end of the pressing element 61 needs to be considered at the same time. In designing a nail gun, both of the predetermined length and the depths of the recesses 640, 650 needs to be considered together. It not easy for the prior art to design a pressing element that can accommodate two different cables due to the fact that the recess engaged with the urging element 67 has an effect on the predetermined length of the pressing element 61 out of the case 50. Thus, there is a need to further improve the utility model.

### SUMMARY OF THE INVENTION

The primary object of the present invention is to provide a nail gun with a multi-gauge structure for a variety of cables to facilitate the operation and the carnage.

Another object of the present invention is to provide a nail gun with a multi-gauge structure that can simplify the construction and facilitate the design to reduce the manufacturing cost and increase economic benefits.

In accordance with the embodiments of the present invention, the nail gun can be applied for a variety of cables via changing a pressing element. Further, each pressing element is provided with two recesses respectively on two ends thereof so that the quantity of the pressing elements earned with the nail gun can be greatly reduced, and the construction of the nail gun can be simplified. According to the embodiments of the present invention, the length of the pressing element extending out of the case can be directly determined by the first or second positioning edges as well as the positioning stops. This feature may facilitate in designing a nail gun for a variety of cables each with a specific diameter or gauge, reduce the manufacturing cost, bring additional values, and increase the economic benefits.

Other objects, advantages, and novel features of the present invention will become more apparent from the following detailed description when taken in conjunction with the accompanying drawings.

### BRIEF DESCRIPTION OF THE DRAWINGS

FIG. 1 is an exploded view of a nail according to the present invention, for illustrating the parts of the present invention and the relationship of the parts.

FIG. 1A is an enlarged view of a portion of FIG. 1.

FIG. 2 is a 3-dimensional view of a pressing element of the nail gun.

FIG. 3 is an enlarged side view of the pressing element of the nail gun, which shows the status of the nail gun in accommodating a cable via the first recess of the pressing element before a trigger.

FIG. 4 is an enlarged front view of the pressing element of the nail gun, which shows the status of the nail gun in accommodating a cable via the first recess of the pressing element before trigger.

FIG. 5 is an enlarged side view of the pressing element of the nail gun, which shows the status of the nail gun in accommodating a cable via the first recess of the pressing element after a trigger.

FIG. 6 is an enlarged front view of the pressing element of the nail gun, which shows the status of the nail in accommodating a cable via the first recess of the pressing element after a trigger.

FIG. 7 is an enlarged side view of the pressing element of the nail gun, which shows the status of the nail gun in accommodating a cable via the second recess of the pressing element before a trigger.

FIG. 8 is an enlarged front view of the pressing element of the nail gun, which shows the status of the nail gun in accommodating a cable via the second recess of the pressing element before a trigger.

FIG. 9 is an enlarged side view of the pressing element of the nail gun, which shows the status of the nail gun in accommodating a cable via the second recess of the pressing element after a trigger.

FIG. 10 is an enlarged front view of the pressing element of the nail gun, which shows the status of the nail gun in accommodating a cable via the first recess of the pressing element after a trigger.

FIG. 11 is an exploded view of another embodiment of a nail gun according to the present invention, for illustrating the parts of the embodiment.

FIG. 11A is an enlarged view of a portion of FIG. 11.

FIG. 12 is an exploded view of a nail gun of prior art.

FIG. 12A is an enlarged view of a portion of FIG. 12.

### DETAILED DESCRIPTION OF THE PREFERRED EMBODIMENTS

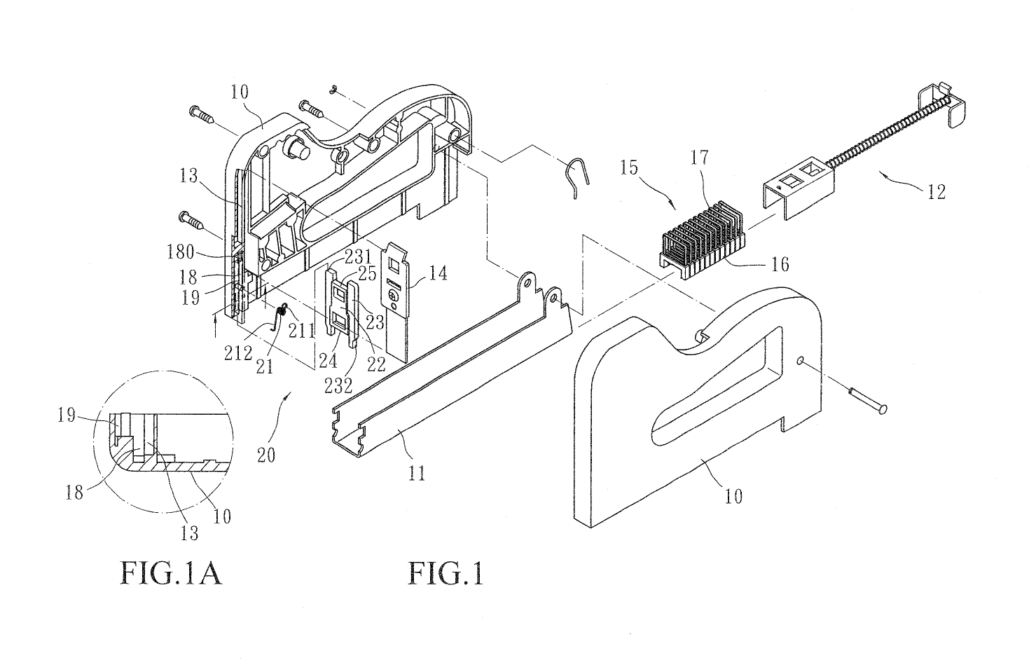

The present invention relates to a nail gun with a multi-gauge structure for a variety of cables, each with a specific diameter. As disclosed in FIG. 1, the nail gun comprises a case 10 having two corresponding halves. A tract 11 is adapted to be mounted in a lower portion of the case 10. A pusher 12 is slidably fitted with the tract 11. A driving slot 13 is defined in front of the tract 11 substantially at a front portion of the case 10. A driving blade 14 is slidably mounted in the driving slot 13 to create a downward impact force. A staple packet 15 can be pushed by the pusher 12 to be lined up in the tract 11. The staple packet 15 includes a plurality of staples 17 and seats 16, which are sequentially arranged. The driving blade 14 can be driven to strike one of the staples 17 to have it fixed into a wall or floor and compress the corresponding seat 16 to secure cables 30, 35 (see FIG. 6, FIG. 10).

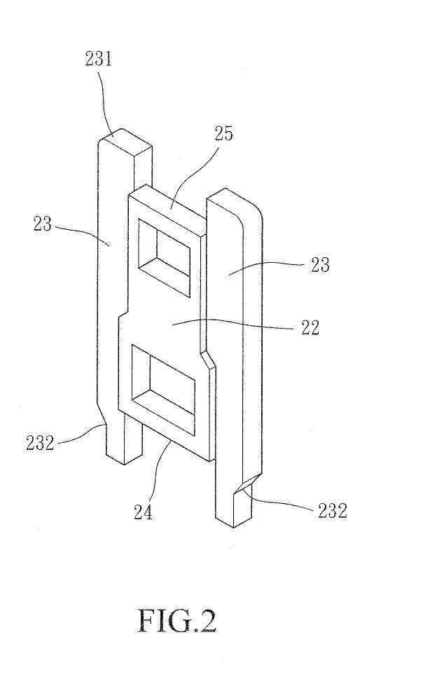

Now, please refer to FIGS. 1-4, which further illustrates the features and the detailed construction of the present invention. The nail gun is featured to have a multi-gauge structure or an improved cable-pressing structure as follows. The improved cable-pressing structure includes a pressing mechanism 20 mounted in front of the driving slot 13 of the case 10. The pressing mechanism 20 includes a clamping element 21 and at least one pressing element 22. Furthermore, the improved cable-pressing structure is featured to have an inserting slot 18 and a holding slot 19 sequentially defined in front of the driving slot 13 in the case 10. The inserting slot 18 is located between the holding slot 19 and the driving slot 13. The clamping element 21 is pivotally mounted in the holding slot 19 of the case 10. The clamping element 21 is formed as a torsional spring-like structure. The clamping element has a counter portion 211 extending toward the inserting slot 18 and an elongated rod 212 attached in the holding slot 19, whereby the counter portion 211 can apply a force toward the inserting slot 18 to urge against the pressing element 22. Furthermore, two positioning stops 180 are respectively formed on two sides of a top surface defining the inserting slot 18 for engaging with two lateral sides of the pressing element 22, which will be detailed in the following. Still Furthermore, the inserting slot 18 can be selectively fitted with one or more than one pressing elements each with a specific gauge.

The pressing element 22 has two strip supports 23 respectively formed on two lateral sides thereof. Each strip support has a first positioning edge 231 formed on one end thereof and a second positioning edge 232 formed on the other end thereof. A first recess 24 is defined between the first positioning edges 231 at one end of the pressing element 22. A second recess 25 is defined between the second positioning edges 232 at the other end of the pressing element 22. The first recess 24 has a depth different from the second recess 25. The pressing element 22 extends out of the bottom of the case 10 at a predetermined length when the positioning edges 231, 232 of the pressing element 22 are engaged with the positioning stops 180 formed within the inserting slot 18 (see FIG. 4, FIG. 8). The recesses 24, 25 can be each designed to have a depth sufficient to accommodate a cable with a specific diameter or gauge. The predetermined length, which is directly determined by the positioning stops 180 and the positioning edges 231, 232, will not be affected by the depths of the recesses 24, 25. This feature will facilitate in designing a nail gun.

Accordingly, a nail gun of simple construction, designed via the pressing mechanism of the present invention, can be applied for a large variety of cables each with a specific diameter or gauge.

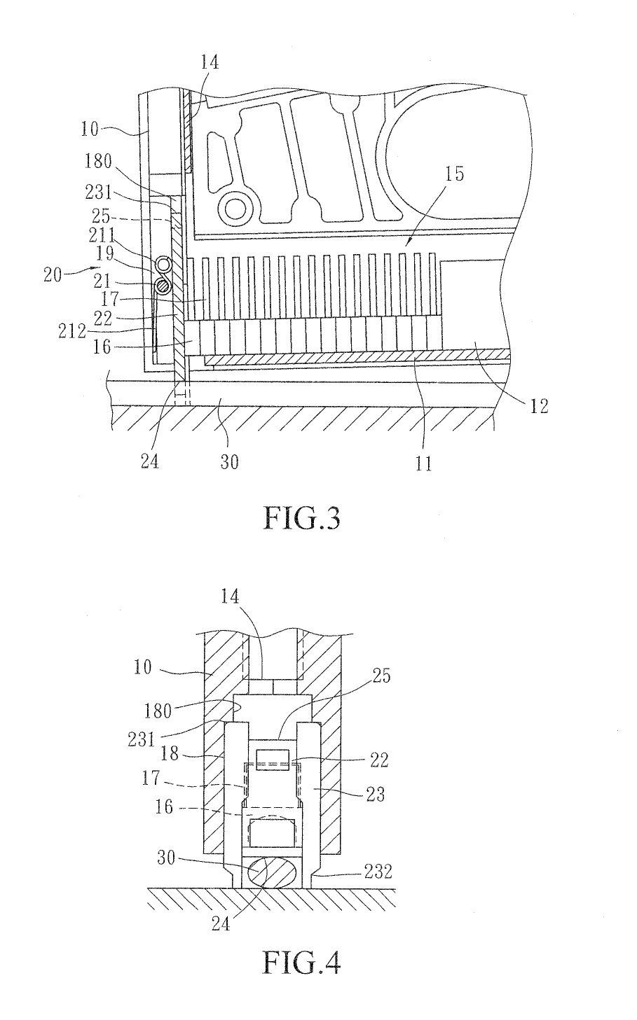

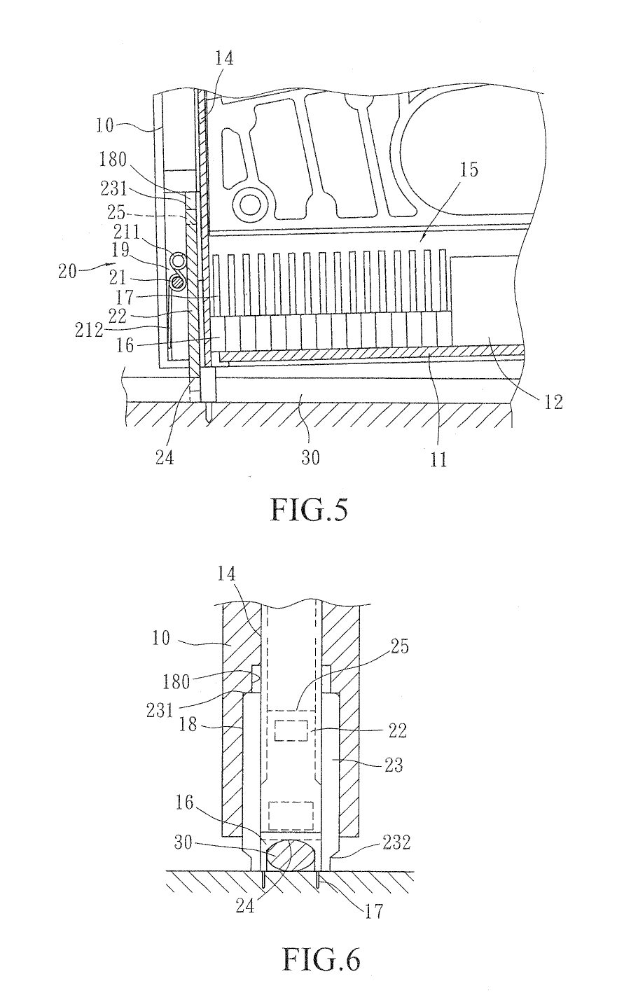

Next, referring to FIGS. 3-6, an illustration for the operation of the present invention will be detailed as follows. In operation, the user can select a pressing element according to the diameter of a cable. For example, the user can select the first recess 24 of a pressing element for a specific cable (suppose the first recess 24 has a depth corresponding to the diameter of the desired cable). Thus, the user can insert the pressing element 22 into the inserting slot 18 to allow the first positioning edge 232 to engage with the positioning stops 180 formed within the inserting slot 18, whereby the first recess 24 can be located outside of the case 10 to accommodate the cable 30. Thus, when the nail gun is triggered, the driving blade 14 can be driven downward to strike one of the staples 17 of the packet 15 to have it fixed into a wall or floor and compress the corresponding seat 17 to secure the cable 30 to the wall or floor.

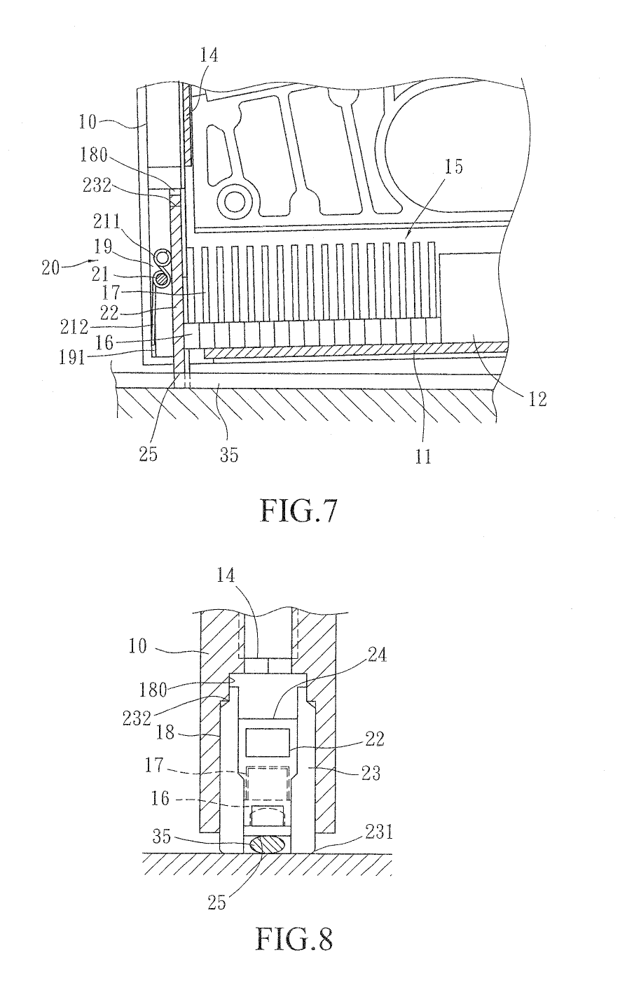

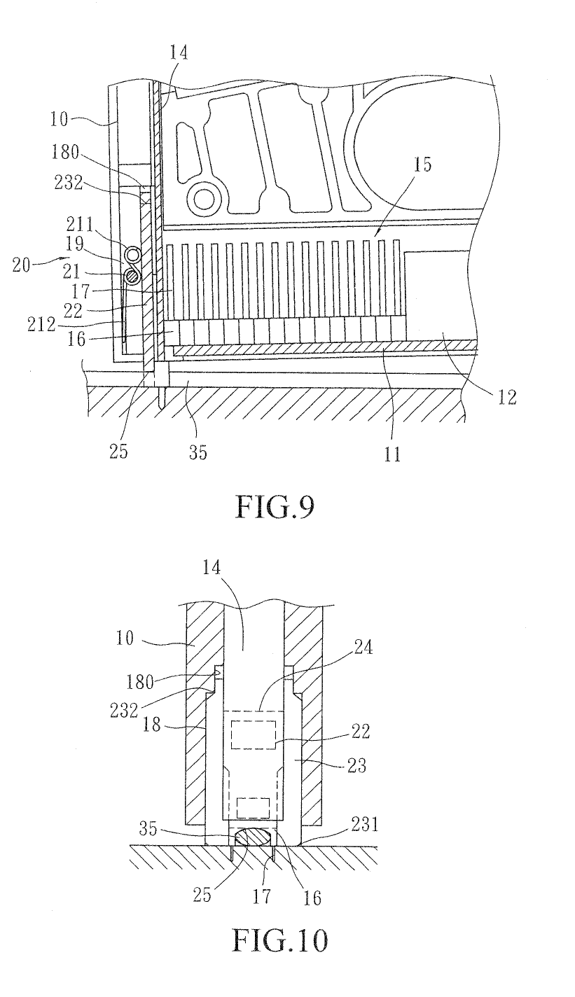

Now, it is supposed that the first recess 25 has a depth corresponding to the diameter of the cable to be applied for. In such condition, referring to FIGS. 7-10, the user can take out the pressing element 22, invert the pressing element 22, and insert the pressing element 22 back into the inserting slot 18 to allow the second positioning edges 232 of the pressing element 22 to engage with the positioning stops 180 formed within the inserting slot 18, whereby the second recess 25 can be located outside of the case 10 to accommodate the cable 35. Thus, when the nail gun is triggered, the driving blade 14 can be driven downward to strike one of the staples 17 of the packet 15 to have it fixed into a wall or floor and compress the corresponding seat 17 to secure the cable 30, 35 to the wall or floor.

In view of the foregoing, the nail gun of the present invention can be applied to a large variety of cables each with a specific diameter or gauge via selection of a pressing element 22. Each pressing element 22 is designed to have two recesses with different depths so that each pressing element 22 can be applied for two cables with different diameters. Thus, the quantity of the pressing element 22 carried with the nail gun can be greatly reduced and the construction of the nail gun can be further simplified. The length of the pressing element 22 out of the bottom of the case 10 will not be affected when changing the depths of the recesses 24, 25. This feature can simplify the design for a specific cable. Thus, the design for a cable with a specific diameter or gauge can be proceeded more smoothly than the conventional art. The manufacturing cost can thus be reduced.

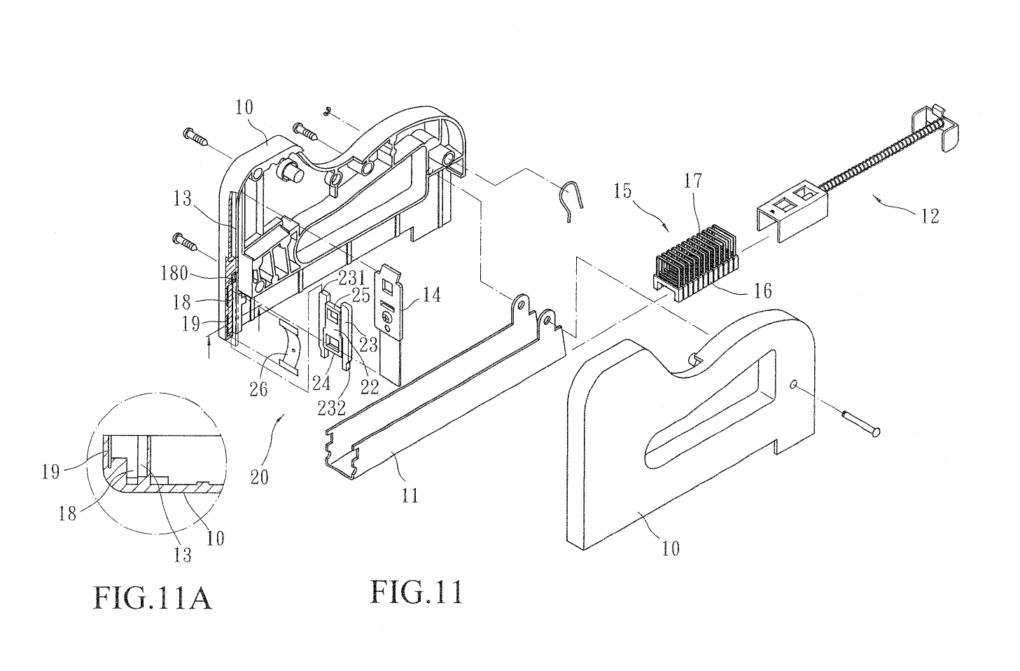

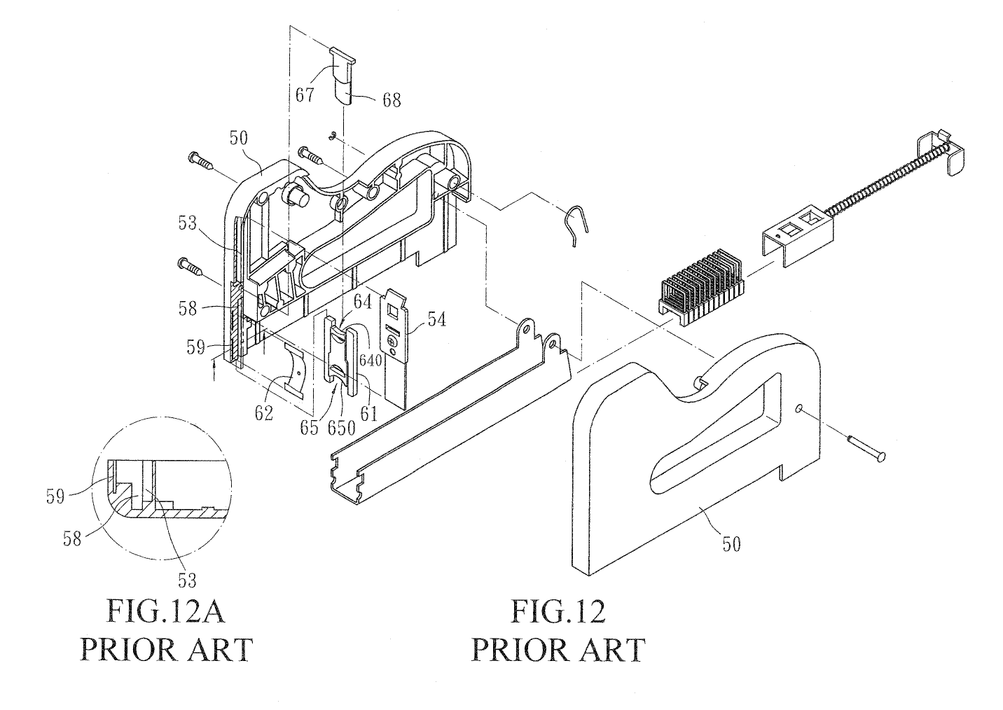

Referring to FIGS. 11 and 11A, another embodiment of the present invention is disclosed, wherein the clamping mechanism 20 includes a clamping element 26 of a leaf spring. The clamping element 26 has an arch-shaped portion extending toward the inserting slot 18 to apply a force on the pressing element 22. This embodiment has the same advantages and utilities as the aforementioned embodiment.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A nail gun comprising a case with two corresponding halves, a track adapted to be mounted in a lower portion of said case, and a pusher slidably fitted with said track capable of pushing a staple packet forward along said track, wherein said case defines a driving slot in front of said track substantially at a front portion of said case, a driving blade is slidably mounted in said driving slot;
wherein the nail gun has an improved wire-pressing structure formed in front of said driving slot substantially at a front portion of said case to sequentially define a receiving slot and a holding slot in front of said driving slot, said improved wire-pressing structure includes a clamping element mounted in said holding slot for applying a force toward said receiving slot, said improved wire-pressing structure further includes two positioning stops respectively formed on two sides of a top surface defining said inserting slot, whereby said inserting slot can be selectively fitted with one or more than one pressing element each with a design for a cable with a specific diameter; and
further wherein each said pressing element is formed with two strip supports respectively on two lateral sides thereof, each strip support is formed with a first positioning edge and a second positioning edge respectively on two ends thereof, a first recess is defined between said first positioning edges at one end of said pressing element, a second recess is defined between said second positioning edges at the other end of said pressing element, said first recess has a depth different from said second recess, said first recess corresponds to said first positioning edges, said second recess corresponds to said second positioning edges.

2. The nail gun of claim 1, wherein said clamping element is a torsional spring-like structure that has a counter portion and an elongated rod, said counter portion extending toward said inserting slot, said elongated rod being attached in said holding slot.

3. The nail gun of claim 1, wherein said clamping element is a leaf spring having an arch-shaped portion extending toward said inserting slot.
